(19) United States
(12) Patent Application Publication
(10) Pub. No.: US 2024/0131460 A1
(43) Pub. Date: Apr. 25, 2024

(54) FILTER FASTENING UNIT ASSEMBLY AND FILTER FASTENING UNIT

(71) Applicant: KYUNGDONG NAVIEN CO., LTD., Pyeongtaek-si (KR)

(72) Inventors: Min Seop Oh, Seoul (KR); Chan Woo Lee, Seoul (KR); Tae Seop Shin, Seoul (KR)

(21) Appl. No.: 18/379,909

(22) Filed: Oct. 12, 2023

(30) Foreign Application Priority Data
Oct. 20, 2022 (KR) 10-2022-0136507

(51) Int. Cl. B01D 35/30; B01D 61/10

(52) U.S. Cl. CPC B01D 35/306; B01D 61/10; B01D 2201/167; B01D 2201/30

(57) ABSTRACT

Disclosed are a filter fastening unit assembly and a filter fastening unit. The filter fastening unit assembly includes a filter, and a filter fastening unit, to which the filter is coupled, the filter fastening unit includes a base having a base opening opened toward a first direction that is one direction that is perpendicular to an upward/downward direction, a housing disposed in the base opening, connected to the base to be movable upwards and downwards, and having a housing opening opened toward the first direction, a filter coupling part coupled to an upper side of the base, and including an introduction passage, though which water is introduced, and a discharge passage, through which the water is discharged, and a lever connected to the base to be rotatable, and connected to the housing to be rotatable.

### CROSS-REFERENCE TO RELATED APPLICATION

This application claims the benefit of priority to Korean Patent Application No. 10-2022-0136507, filed in the Korean Intellectual Property Office on Oct. 21, 2022, the entire contents of which are incorporated herein by reference.

### TECHNICAL FIELD

The present disclosure relates to a filter fastening unit assembly and a filter fastening unit.

### BACKGROUND

In general, a water purifier is a device for filtering natural water, such as city water or mineral water, and removes harmful substances, such as foreign substances or heavy metals, which are contained in raw water and are harmful to human bodies, by filtering the raw water through various kinds of filters.

The water purifier may include a pre-treatment filter that filters out large particles and residual chlorine in raw water, an RO filter that filters out foreign substances such as heavy metals, and a post-carbon filter that improves the taste of water.

Two ways to replace these filters include a scheme of directly connecting a fitting to a flow passage of the filter and using a separate fastening unit for a one-touch assembly. Among them, according to the scheme of directly connecting the fitting to the flow passage of the filter, a tool is necessary when the filter is attached and detached, and it is difficult for a general user to replace it.

Furthermore, the one-touch connection scheme includes a structure for fixing a filter and a fastening unit body while the filter and the fastening unit body are rotated. The structure, in which the fastening unit body is rotated, has a large number of parts and a complex passage structure.

### SUMMARY

The present disclosure has been made to solve the above-mentioned problems occurring in the prior art while advantages achieved by the prior art are maintained intact.

An aspect of the present disclosure provides a filter fastening unit assembly, by which a filter may be conveniently attached and detached without using a tool with a one-touch filter exchange structure by a general consumer, and a filter fastening unit.

Another aspect of the present disclosure provides a filter fastening unit assembly that has simple kinds of parts and a simple passage structure, and a filter fastening unit.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a filter fastening unit assembly includes a filter, and a filter fastening unit, to which the filter is coupled, the filter fastening unit includes a base having a base opening opened toward a first direction that is one direction that is perpendicular to an upward/downward direction, a housing disposed in the base opening, connected to the base to be movable upwards and downwards, and having a housing opening opened toward the first direction, a filter coupling part coupled to an upper side of the base, and including an introduction passage, though which water is introduced, and a discharge passage, through which the water is discharged, and a lever connected to the base to be rotatable, and connected to the housing to be rotatable, and the filter is configured to be disposed in the housing opening, and move upwards in conjunction of upward movement of the housing due to rotation of the lever to be connected to the filter coupling part.

As another example, the filter may include a filter body, and a filter boss protruding in at least any one of a second direction that is one direction that is perpendicular to the upward/downward direction and the first direction, and a third direction that is an opposite direction to the second direction, and the housing includes a boss insertion recess opened toward the first direction, and into which the filter boss is inserted.

As another example, the housing may include a housing body having the boss insertion recess, a first extension part extending from the first direction of an insertion area of the housing body, which defines the boss insertion recess, toward a protrusion direction corresponding to the upward/downward direction, which is a direction that faces the filter boss, and a second extension part extending from the first extension part in an opposite direction to the first direction.

As another example, when a space famed between the second extension part and the insertion area when no external force is applied to the second extension part is defined as a spacing space, the second extension part may be configured to be curved with respect to the first extension part, and at least a portion thereof may be disposed in the spacing space when an external force is applied toward the spacing space.

As another example, the spacing space may include a first spacing space located in the opposite direction to the first direction of the second extension part and extending upwards and downwards, and a second spacing space located in an opposite direction to the protrusion direction of the second extension part, and connected to the first spacing space.

As another example, a length of an end in the opposite direction to the first direction of the second extension part, along the upward/downward direction, may be larger than a length of an end in the first direction of the second extension part, along the upward/downward direction.

As another example, a lever boss protruding toward the housing may be formed at an end of the lever in the opposite direction to the first direction, and the housing may include a housing body, and a lever boss guide groove formed in the housing body, opened in the first direction and the opposite direction thereto, and into which the lever boss is inserted.

As another example, a rotation point that is a point, at which the lever is connected to the base to be rotatable, may be formed in the first direction of the lever boss.

As another example, the lever may include a pressing area, and a connection area extending from the pressing area in a direction crossing a direction, in which the pressing area extends, and connected to the base.

As another example, the filter may include a filter body, and a lever stopping step protruding from the filter body in the first direction, and the lever may include a stopping step insertion opening opened toward an upper side such that the lever stopping step is disposed in an interior thereof when the lever is rotated with respect to the base such that the lever boss is located at an uppermost end of a movement range.

As another example, the base may further include a base body, and a through hole formed in the base body, and passing along a second direction that is one direction that is perpendicular to the first direction, and the lever may include a stop member coupled to the through hole through snap-fitting when the lever is rotated with respect to the base such that the lever boss is located at an uppermost end of a movement range.

As another example, the base may include a base body, and a housing guide hole formed to pass through the base body, and extending along the upward/downward direction, and the housing may include a housing body, and a housing guide boss protruding from the housing body toward the housing guide hole, and disposed in an interior of the housing guide hole.

As another example, the introduction passage may be opened when the filter and the filter coupling part contact each other.

As another example, a communication hole communicated in the upward/downward direction may be formed on a lower side of the introduction passage, the filter coupling part may include a valve member having a first area having a diameter that is smaller than a diameter of the communication hole to be disposed in an interior of the communication hole, and a second area located on an upper side of the first area and having a diameter that is larger than a diameter of the communication hole, and an elastic member that elastically supports the valve member toward a lower side, and the filter may include a filter body, and a valve opening boss protruding from the filter body toward an upper side, and that presses a lower end of the valve member upwards to open the communication hole closed by the second area.

As another example, the filter coupling part may include an elastic member disposition space, in which the elastic member is disposed in an interior thereof, and the introduction passage may not overlap the elastic member disposition space when viewed along an extension direction of the introduction passage.

According to another aspect of the present disclosure, a filter fastening unit assembly includes a base having a base opening, a housing disposed in the base opening, connected to the base to be movable upwards and downwards, and having a housing opening, a filter coupling part coupled to an upper side of the base, and including an introduction passage, through which water is introduced, and a discharge passage, through which the water is discharged, and a lever connected to the base to be rotatable, connected to the housing to be rotatable, and that moves the housing upwards and downwards when being rotated with respect to the base.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view of a filter fastening unit assembly according to an embodiment of the present disclosure;

FIG. 2 is an exploded view of FIG. 1;

FIG. 3 is a perspective view illustrating a state, in which a filter is separated from a filter coupling part;

FIG. 4 is a view when FIG. 3 is viewed from a second direction;

FIG. 5 is a view illustrating a state, in which a base is removed in FIG. 4;

FIG. 6 is a view a state, in which a filter is moved to be connected to a filter coupling part, from a second direction;

FIG. 7 is an enlarged view illustrating a part of FIG. 6, in which a base is removed;

FIG. 8 is a perspective view illustrating a state, in which a filter is connected to a filter coupling part;

FIG. 9 is a view of FIG. 8, viewed from a second direction;

FIG. 10 is a cross-sectional view of a case, in which a filter and a filter coupling part are connected to each other; and

FIG. 11 is a cross-sectional view of a case, in which a filter and a filter coupling part are separated.

### DETAILED DESCRIPTION

Hereinafter, embodiments of the present disclosure will be described in detail with reference to the accompanying drawings. In adding reference numerals to the components of the drawings, it is noted that the same components are denoted by the same reference numerals even when they are drawn in different drawings. Furthermore, in describing the embodiments of the present disclosure, when it is determined that a detailed description of related known configurations and functions may hinder understanding of the embodiments of the present disclosure, a detailed description thereof will be omitted.

In the specification, a forward/rearward direction, a leftward/rightward direction, and an upward/downward direction are referred for convenience of description, and may be directions that are perpendicular to each other. However, the directions are determined relative to a direction, in which a filter fastening unit assembly is arranged, and the upward/downward direction does not always mean a vertical direction.

Furthermore, a term of a passage used hereinafter may mean a pipe-shaped pipeline, through which a fluid may flow in an interior thereof, and means a component, a flexible tube or a metal pipe, which may have various materials and shapes.

A filter fastening unit assembly according to an embodiment of the present disclosure may be an assembly of a filter fastening unit and a filter 50. The filter fastening unit may be a unit for coupling the filter 50 used in a water purifier.

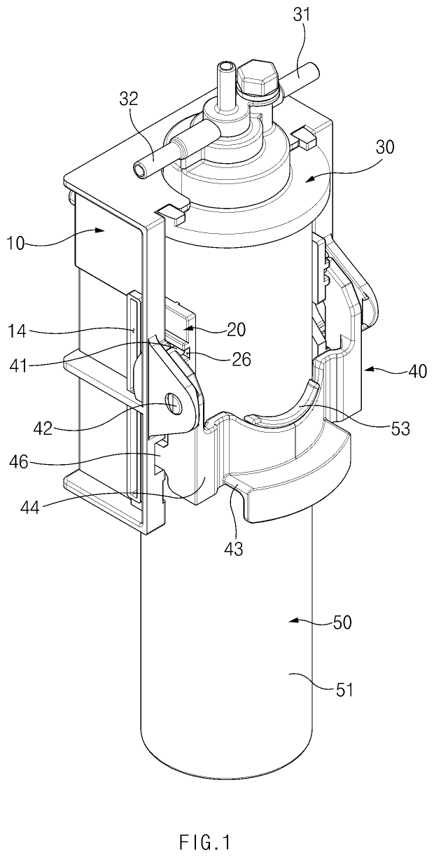

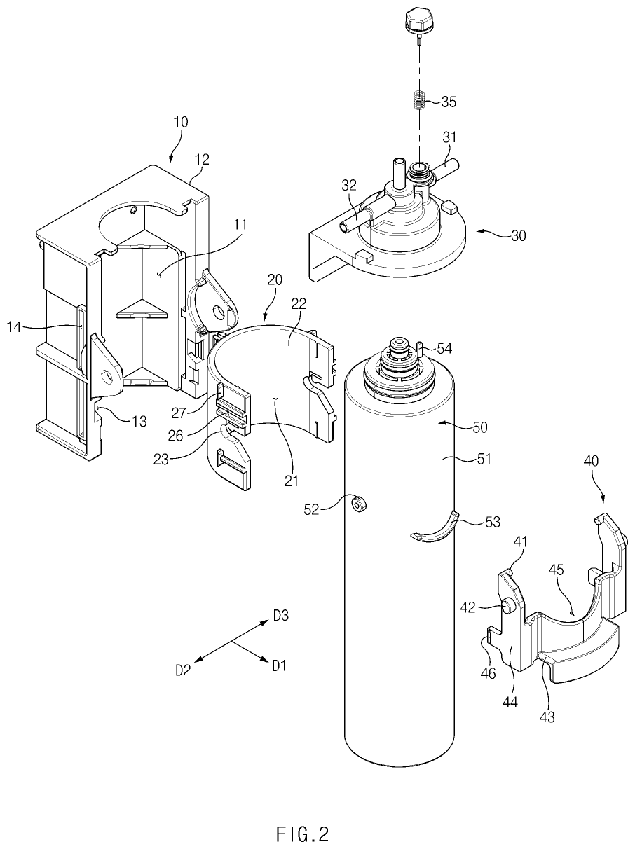

First, basic components of the filter fastening unit assembly according to an embodiment of the present disclosure will be described in detail with reference to the accompanying drawings. FIG. 1 is a perspective view of a filter fastening unit assembly according to an embodiment of the present disclosure. FIG. 2 is an exploded view of FIG. 1.

The filter fastening unit assembly according to an embodiment of the present disclosure may include the filter 50 and a filter fastening unit. The filter fastening unit may include a base 10, a housing 20, a filter coupling part 30, and a lever 40.

The base 10 may include a base opening 11. The base opening 11 may be opened in a first direction D1 that is one direction that is perpendicular to an upward/downward direction.

The housing 20 may be disposed in the base opening 11. The housing 20 may be connected to the base 10 to be movable upwards and downwards.

The housing 20 may include a housing opening 21 that is opened toward the first direction D1. The filter 50 may be disposed in the housing opening 21.

The filter coupling part 30 may be coupled to an upper side of the base 10. The filter coupling part 30 may include an introduction passage 31, through which the water is introduced, and a discharge passage 32, through which the water is discharged. The water introduced through the introduction passage 31 is discharged through the discharge passage 32 via the filter 50 coupled to the filter coupling part 30. In this process, the water that passes through the filter 50 may be purified.

The lever 40 may be connected to the base 10 to be rotatable, and may be connected to the housing 20 to be rotatable. The lever 40 may move the housing 20 upwards and downwards with respect to the base 10. The lever 40 may include a pressing area 43, and a connection area 44 that extends from the pressing area 43 in a direction that crosses a direction, in which the pressing area 43 extends, and is connected to the base 10.

The filter 50 may be disposed in the housing opening 21. The filter 50, as an example, may be a reverse osmosis (RO) filter, but the present disclosure is not limited thereto, and various modifications, such as a hollow fiber membrane filter and a nano filter.

The filter 50 may be moved upwards in conjunction with upward movement of the housing 20 due to rotation of the lever 40 to be connected to the filter coupling part 30. Here, the connection to the filter coupling part 30 may mean contact of an upper end of the filter 50 with the filter coupling part 30. When the filter 50 is connected to the filter coupling part 30, the water introduced through the introduction passage 31 may be introduced into an interior of the filter 50 and may be purified.

Similarly, the filter 50 may be moved upwards in conjunction with the upward movement of the housing 20 due to the rotation of the lever 40 to be separated from the filter coupling part 30. In this case, the filter 50 may be separated from the housing 20 to be replaced.

According to the present disclosure, because the filter 50 may be attached and detached through a one-touch structure using the lever 40, the filter 50 may be conveniently assembled without using a separate tool when the filter 50 is attached and detached, and thus, working performance may be enhanced.

Furthermore, according to the present disclosure, because parts and passage structures are simply formed such that the filter 50 is attached and detached by using the lever 40 while the filter 50 is not rotated, production costs may be reduced.

Hereinafter, detailed shapes of the parts will be described in detail.

<Structure for Connecting Base 10 and Housing 20>

The base 10 may include a base body 12 and a housing guide hole 14. The housing guide hole 14 may be formed to pass through the base body 12, and may extend along the upward/downward direction. A plurality of housing guide holes 14 may be provided. As an example, an even number of housing guide holes 14 may be provided, and may be disposed to be spaced apart from each other upwards and downwards.

The housing 20 may include a housing body 22, and a housing guide boss 27 that protrudes from the housing body 22 toward the housing guide hole 14 to be disposed in an interior of the housing guide hole 14. The number of housing guide bosses 27 may correspond to the number of housing guide holes 14.

However, this is a simple example, and the bosses may be formed in the base 10 and the holes may be formed in the housing 20, and in addition, various modifications may be made in a range that allows relative upward and downward movements.

<Structure for Connecting Filter 50 and Housing 20>

The filter 50 may include a filter body 51 and a filter boss 52. The filter body 51 may extend in the upward/downward direction. The filter boss 52 may protrude from the filter body 51 in at least one of a second direction D2 and a third direction D3. The second direction D2 may be one direction that is perpendicular to the upward/downward direction and the first direction D1. The third direction D3 may be an opposite direction to the second direction D2. The filter boss 52 may be a member for connecting the filter 50 and the housing 20.

The housing 20 may include a boss insertion recess 23. The boss insertion recess 23 may be formed in the housing body 22. The boss insertion recess 23 may be a recess that is opened toward the first direction D1, and into which the filter boss 52 is inserted.

The housing 20 may further include a first extension part 24 and a second extension part 25. For convenience of description, an insertion area and a protrusion area will be defined. The insertion area may mean an area of the housing body 22, which defines the boss insertion recess 23. The protrusion area may mean a direction in the upward/downward direction, which faces the filter boss 52.

The first extension part 24 may extend from a side of the insertion area in the first direction D1 toward the protrusion direction. With reference to FIG. 1, the protrusion direction may be a downward direction. The second extension part 25 may extend from the first extension part 24 in an opposite direction to the first direction D1. This may be understood that the first extension part 24 and the second extension part 25 have “L” shapes.

Due to the shapes of the first extension part 24 and the second extension part 25, a spacing space is present in a relationship with the insertion area. The spacing space may mean a space that is formed between the second extension part 25 and the insertion area when no external force is applied to the second extension part 25.

The spacing space may include a first spacing space and a second spacing space. The first spacing space may be located in an opposite direction to the first direction D1 of the second extension part 25 to extend upwards and downwards. The second spacing space may be located in the opposite direction to the protrusion direction of the second extension part 25 and may be connected to the first spacing space. This may mean that the spacing space also has an “L” shape.

Meanwhile, the second extension part 25 may be provided to be curved with respect to the first extension part 24 and at least a portion thereof may be disposed in the spacing space when an external force is applied toward the spacing space. The curving may include a case, in which the second extension part 25 itself has elasticity. This may be a structure for hindering the above-described filter boss 52 from being extracted after being inserted into the boss insertion recess 23.

Accordingly, in a range of the effect, the first extension part 24 and the second extension part 25 may be variously modified. As an example, the second extension part 25 may be coupled to be rotatable with respect to the first extension part 24. As another example, the first extension part 24 may be coupled to be rotatable with respect to the insertion area.

A length of an end of the second extension part 25 in the opposite direction to the first direction D1, along the upward/downward direction, may be longer than a length of an end of the second extension part 25 in the first direction D1, along the upward/downward direction. As an example, the end of the second extension part 25 in the opposite direction to the first direction D1 may include a part that protrudes toward the protrusion direction. As another example, the second extension part 25 may have a shape that protrudes toward the protrusion direction when it goes toward the opposite direction to the first direction D1.

The shape may hinder the filter boss 52 from being moved in the opposite direction to the first direction D1 when the filter 50 is coupled to the housing 20, the second extension part 25 from being disposed in the boss insertion recess 23 after the second extension part 25 is pushed in the opposite direction to the protrusion direction, and the filter boss 52 from being moved in the first direction D1 while the second extension part 25 is restored.

In detail, when the filter 50 is coupled to the housing 20, first, an upper portion of the filter 50 passes through a space between the lever 40 and the housing 20. In this process, the filter boss 52 is moved along an inlet end of the boss insertion recess 23. In this process, the filter boss 52 may be moved in the opposite direction to the first direction D1, and may be disposed in the boss insertion recess 23 after pushing the second extension part 25 in the opposite direction to the protrusion direction.

<Structure for Connecting Lever 40 and Housing 20>

A lever boss 41 that protrudes toward the housing 20 may be formed at an end of the lever 40 in the opposite direction to the first direction D1. The housing 20 may include a lever boss guide groove 26. The lever boss guide groove 26 may be formed in the housing body 22 and may be opened in the first direction D1 and the opposite direction thereto. The lever boss guide groove 26 may be configured such that the lever boss 41 is inserted thereinto.

Meanwhile, a rotation point 42 that is a point, at which the lever 40 is connected to the base 10 to be rotatable, may be formed in the first direction D1 of the lever boss 41. Through the structure, the lever 40 may move the housing 20 upwards and downwards while being rotated with respect to the base 10, and in this process, the filter 50 may be connected to or separated from the filter coupling part 30.

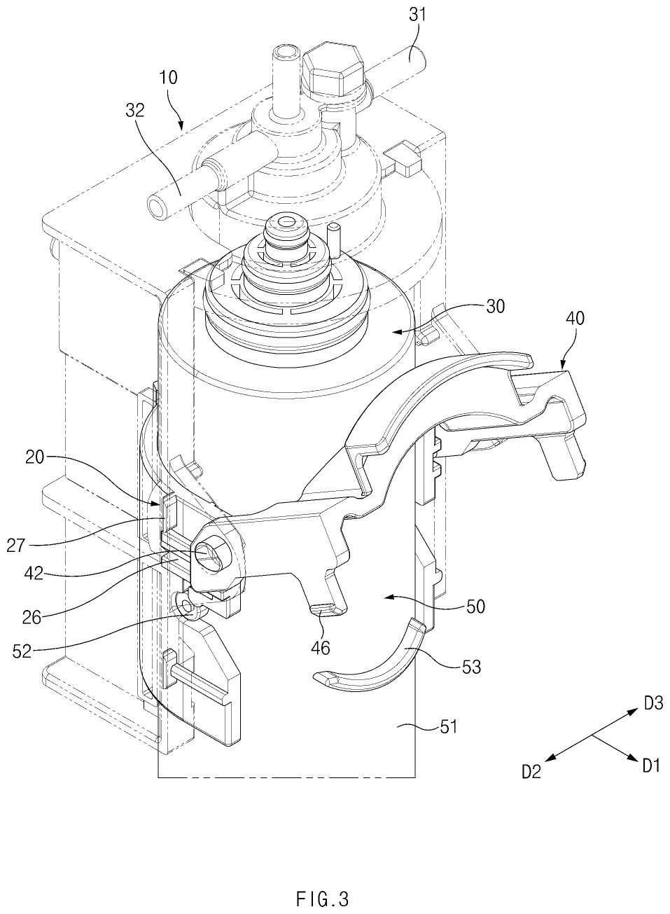

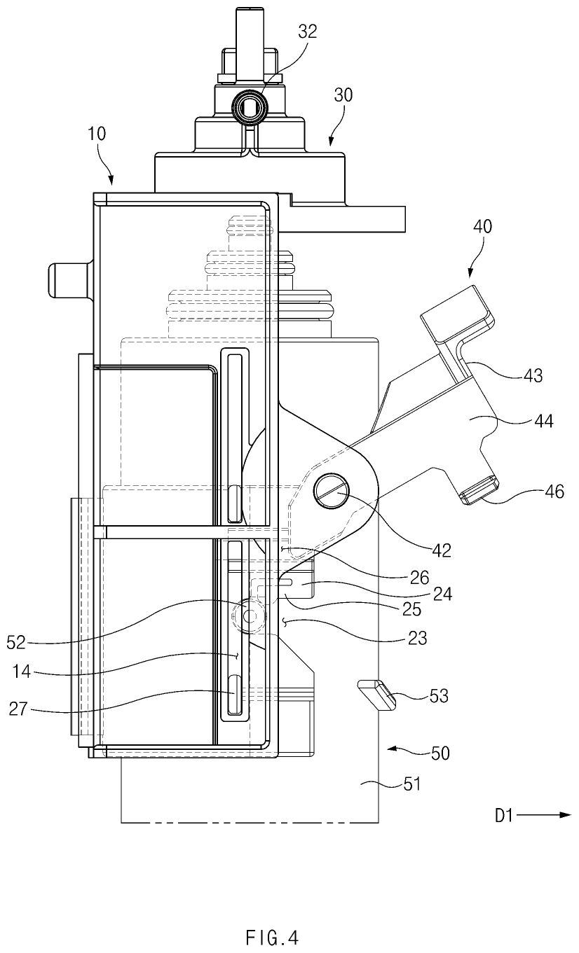

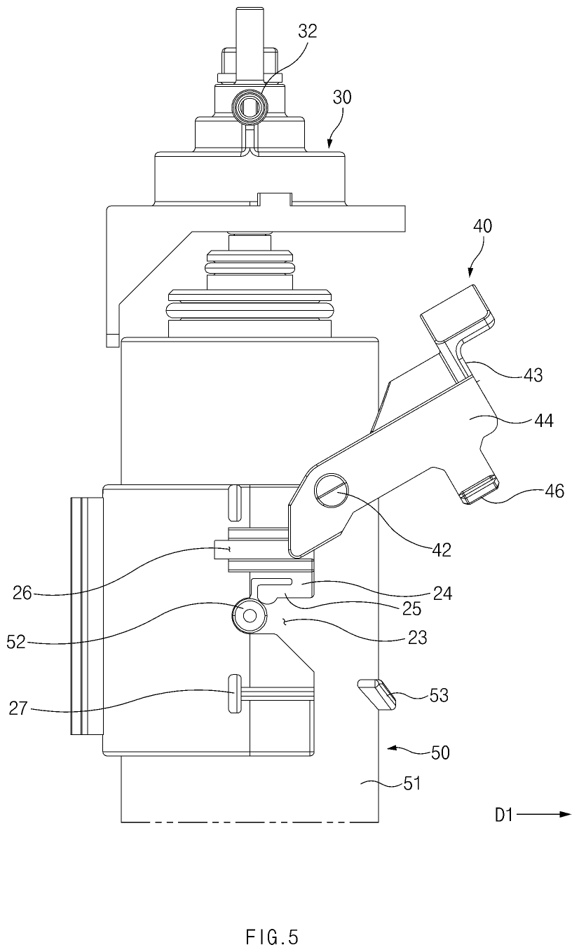

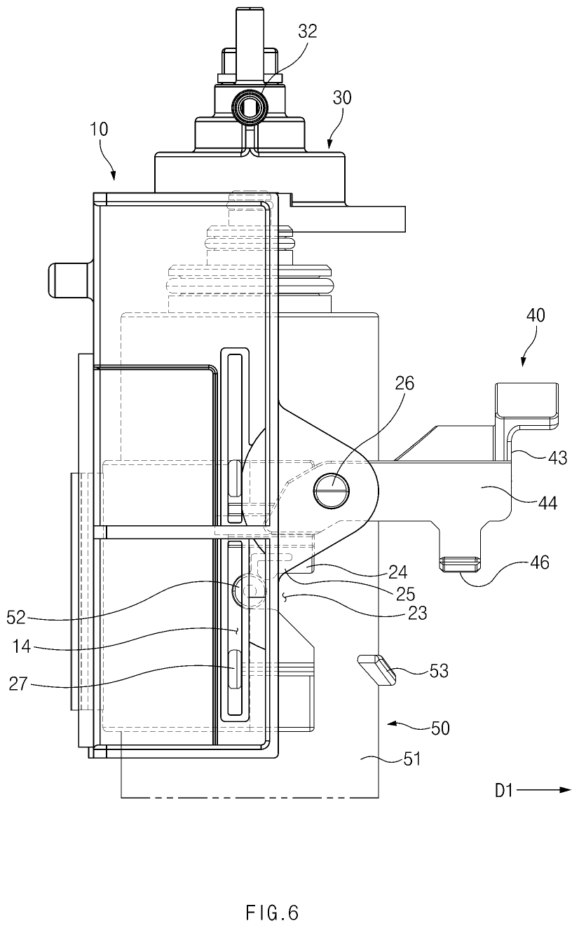

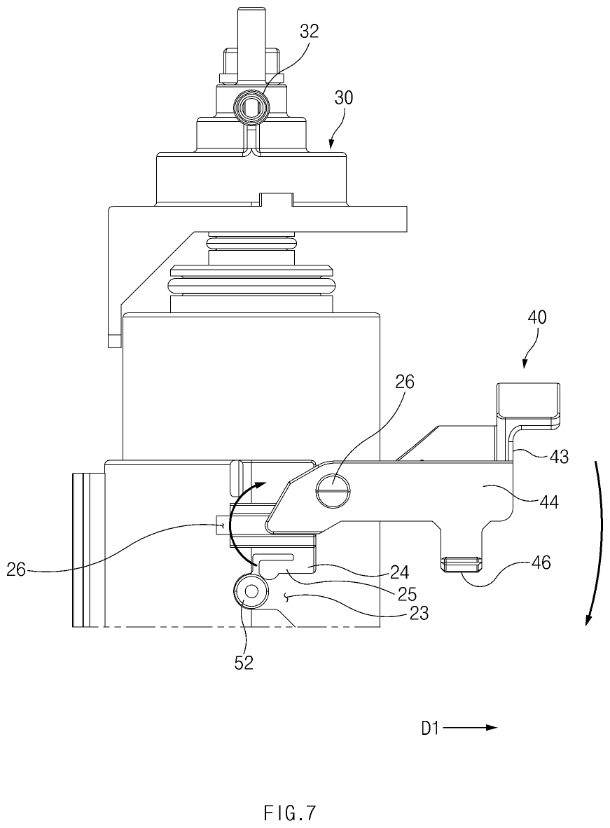

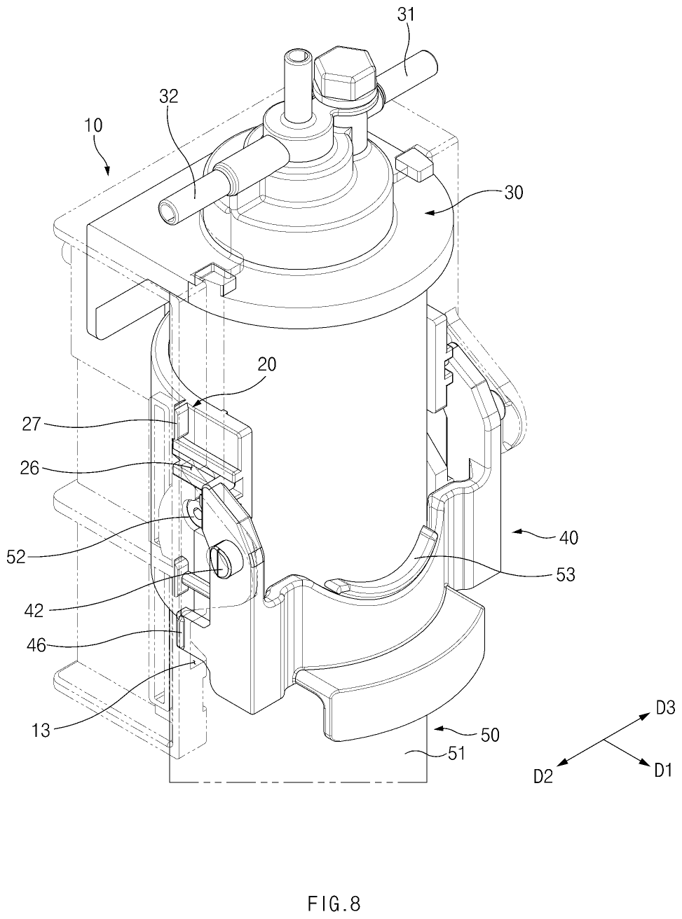

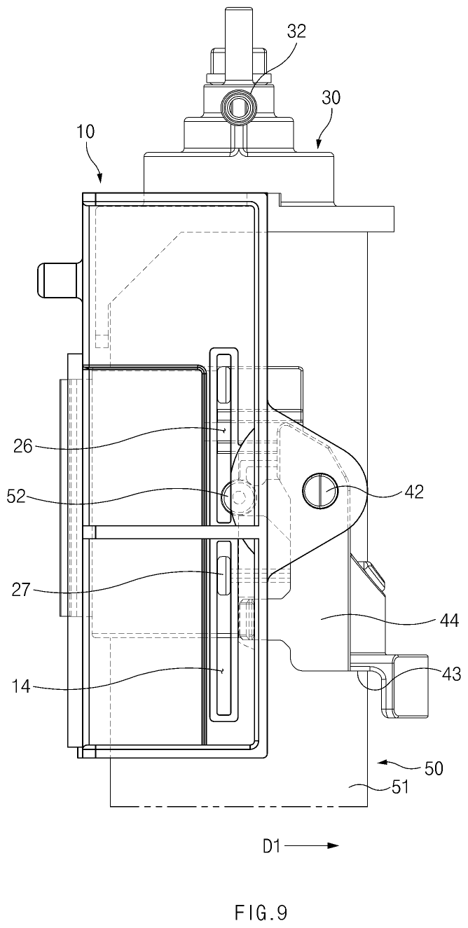

The operation will be described in detail with reference to the drawings. FIG. 3 is a perspective view illustrating a state, in which the filter is separated from the filter coupling part. FIG. 4 is a view when FIG. 3 is viewed from the second direction. FIG. 5 is a view illustrating a state, in which a base is removed in FIG. 4. FIG. 6 is a view of a state, in which the filter is moved to be connected to the filter coupling part 30, viewed from the second direction. FIG. 7 is an enlarged view illustrating a part of FIG. 6, in which a base is removed. FIG. 8 is a perspective view illustrating a state, in which the filter is connected to the filter coupling part. FIG. 9 is a view of FIG. 8, viewed from a second direction. For reference, for convenience of description, FIGS. 3 to 9 illustrate some of components that are covered by other components or cover other components by dotted lines.

Basically, a state, in which the filter 50 is separated from the filter coupling part 30, is illustrated in FIGS. 3 to 5. In this process, the operator presses the pressing area 43 of the lever 40 downwards. When the pressing area 43 is pressed downwards, the lever 40 is rotated about the rotation point 42, and thus, a side of the lever 40, which is close to the lever boss 41, is moved upwards. Due to the movement of the lever boss 41, the housing 20 is moved upwards. In this process, due to the housing guide hole 14 and the housing guide boss 27, the housing 20 is moved only upwards, and the lever boss 41 is moved while drawing a circle, a center of which is the rotation point 42, and thus, in the process, is moved in the opposite direction to the first direction D1 along the lever boss guide groove 26.

Meanwhile, as illustrated in FIGS. 6 and 7, it may be regarded as the lever boss 41 being maximally moved in the opposite direction to the first direction D1 when the lever boss 41 is disposed in parallel to the rotation point 42 along the first direction D1. Thereafter, the lever boss 41 may be moved in the first direction D1 along the lever boss guide groove 26 while being moved upwards at the same time.

A case, in which the rotation of the lever 40 is completed, is illustrated in FIGS. 8 and 9. In this case, the filter 50 is connected to the filter coupling part 30.

Meanwhile, in this case, when a force that faces an upper side is applied to the lever 40, the filter 50 and the filter coupling part 30 may be disconnected. Hereinafter, a structure capable of maintaining connection of the filter 50 and the filter coupling part 30 even when a force that faces an upper side is partially applied to the lever 40 after the filter 50 and the filter coupling part 30 has be connected to each other will be described in detail.

<Structure 1 for Maintaining Connection of Filter 50 and Filter Coupling Part 30>

The base 10 may include a through hole 13 that is famed in the base body 12 and passes along the second direction D2. The lever 40 may further include a stop member 46. The stop member 46 may be coupled to the through hole 13 through snap-fitting. In detail, the stop member 46 may be coupled to the through hole 13 through snap-fitting when the lever 40 is rotated with respect to the base 10 such that the lever boss 41 is located at an uppermost end of the movement range. Because the lever 40 and the base 10 are connected to each other even through a force that faces an upper side is partially applied to the lever 40 as the stop member 46 is coupled to the through hole 13 through snap-fitting, the lever 40 may be prevented from being rotated and the connection of the filter 50 and the filter coupling part 30 may be maintained.

<Structure for Preventing Generation of Noise>

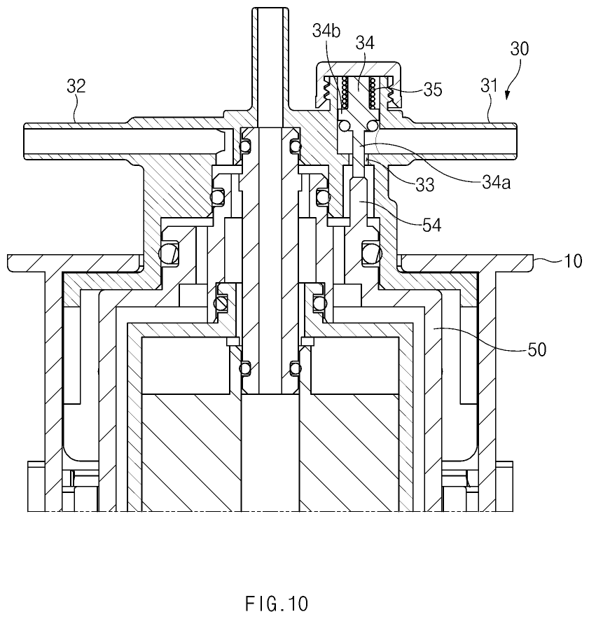

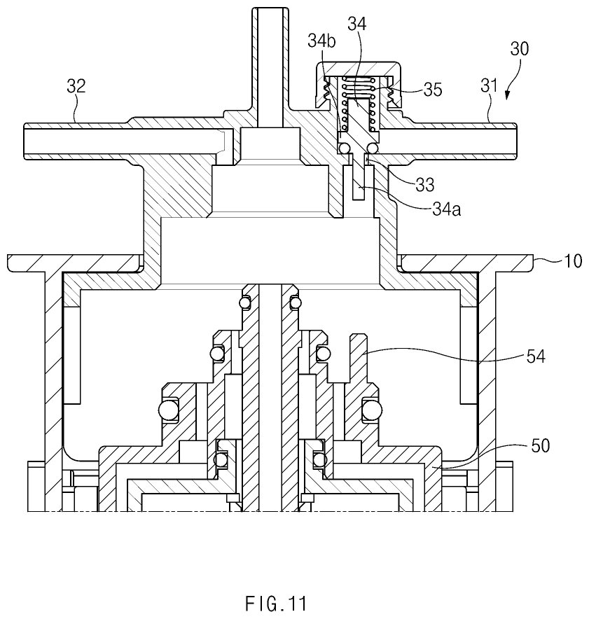

FIG. 10 is a cross-sectional view of a case, in which the filter 50 and the filter coupling part 30 are connected to each other. FIG. 11 is a cross-sectional view of a case, in which the filter 50 and the filter coupling part 30 are separated. The filter fastening unit assembly according to an embodiment of the present disclosure may reduce generation of noise when the water passes. Hereinafter, the structure for preventing generation of the noise will be described in detail with reference to FIGS. 10 and 11.

The introduction passage 31 may be opened when the filter 50 and the filter coupling part 30 contact each other.

As an example, a communication hole 33 that is communicated in the upward/downward direction may be formed on a lower side of the introduction passage 31. The communication hole 33 may be a hole for introducing the water introduced through the introduction passage 31 into the filter 50.

The filter coupling part 30 may include a valve member 34 and an elastic member 35.

The valve member 34 may include a first area 34a and a second area 34b. The first area 34a may be an area having a diameter that is smaller than a diameter of the communication hole 33 to be disposed in an interior of the communication hole 33. The second area 34b may be an area that is located on an upper side of the first area 34a and has a diameter that is larger than a diameter of the communication hole 33. A sealing member, such as an O-ring, may be disposed on a lower side of the second area 34b. When the second area 34b covers the communication hole 33 on an upper side, the water introduced into the introduction passage 31 is prevented from being introduced into the communication hole 33.

The elastic member 35 may elastically support the valve member 34 toward a lower side. As an example, the elastic member 35 may be a spring. As an example, the elastic member 35 may press the second area 34b downwards. Because the elastic member 35 presses the second area 34b downwards, the second area 34b covers the communication hole 33 on an upper side. Accordingly, in this case, the water introduced into the introduction passage 31 is prevented from being introduced into the communication hole 33.

Meanwhile, the filter 50 may include a valve opening boss 54. The valve opening boss 54 may protrude from the filter body 51 toward an upper side. The valve opening boss 54 may be configured to open the communication hole 33 closed by the second area 34b by pressing a lower end of the valve member 34 upwards. This may be understood as a process of switching a state of FIG. 11 to a state of FIG. 10.

Meanwhile, the filter coupling part 30 may include an elastic member disposition space, in which the elastic member 35 is disposed in an interior thereof. When the elastic member disposition space is viewed along an extension direction of the introduction passage 31, the introduction passage 31 may not overlap the elastic member disposition space.

For example, it may be considered that the elastic member is disposed in the introduction passage and is disposed in parallel to the extension direction of the introduction passage, and the elastic member disposition space and the introduction passage 31 overlap each other. In this case, because the elastic member is pressed by the water when the water passes, noise due to vibration may be generated.

According to the present disclosure, because the elastic member disposition space, in which the elastic member 35 that supports the valve member 34 is disposed, does not overlap the introduction passage 31, vibration due to shaking of the elastic member 35 may be reduced when the water passes whereby noise may be reduced.

Meanwhile, when the valve member 34 is pressed downwards by the elastic member 35, the filter 50 and the filter coupling part 30 may be disconnected by pressing the valve opening boss 54 downwards with the valve member 34. Hereinafter, a structure for preventing disconnection of the filter 50 and the filter coupling part 30 due to the valve member 34 will be described in detail.

<Structure 2 for Maintaining Connection of Filter 50 and Filter Coupling Part 30>

The filter 50 may include a lever stopping step 53. The lever stopping step 53 may protrude from the filter body 51 in the first direction D1. The lever 40 may include a stopping step insertion opening 45. The stopping step insertion opening 45 may be opened toward an upper side such that the lever stopping step 53 is disposed in an interior thereof when the lever 40 is rotated with respect to the base 10 such that the lever boss 41 is located at an uppermost end of the movement range. As illustrated in FIG. 8, this may mean that an area of the lever 40, which defines the stopping step insertion opening 45, supports the lever stopping step 53 upwards. Accordingly, because the area of the lever 40, which defines the stopping step insertion opening 45, supports the lever stopping step 53 upwards even though the valve member 34 presses the valve opening boss 54 downwards, the connection of the filter 50 and the filter coupling part 30 may be maintained.

According to the present disclosure, because the filter may be attached and detached through a one-touch structure using a lever, the filter may be conveniently assembled without using a separate tool when the filter is attached and detached whereby working performance may be enhanced.

Furthermore, according to the present disclosure, because parts and a passage structure are simply formed such that the filter is attached and detached by using the lever while the filter is not rotated, production costs may be reduced.

The above description is a simple exemplification of the technical spirits of the present disclosure, and the present disclosure may be variously corrected and modified by those skilled in the art to which the present disclosure pertains without departing from the essential features of the present disclosure. Accordingly, the embodiments disclosed in the present disclosure is not provided to limit the technical spirits of the present disclosure but provided to describe the present disclosure, and the scope of the technical spirits of the present disclosure is not limited by the embodiments. Accordingly, the technical scope of the present disclosure should be construed by the attached claims, and all the technical spirits within the equivalent ranges fall within the scope of the present disclosure.

What is claimed is:

1. A filter fastening unit assembly comprising:
a filter; and
a filter fastening unit, to which the filter is coupled,
wherein the filter fastening unit includes:
a base having a base opening opened toward a first direction that is one direction that is perpendicular to an upward/downward direction;
a housing disposed in the base opening, connected to the base to be movable upwards and downwards, and having a housing opening opened toward the first direction;
a filter coupling part coupled to an upper side of the base, and including an introduction passage, though which water is introduced, and a discharge passage, through which the water is discharged; and
a lever connected to the base to be rotatable, and connected to the housing to be rotatable, and
wherein the filter is configured to:
be disposed in the housing opening; and
move upwards in conjunction of upward movement of the housing due to rotation of the lever to be connected to the filter coupling part.

2. The filter fastening unit assembly of claim 1, wherein the filter includes:
a filter body; and
a filter boss protruding in at least any one of a second direction that is one direction that is perpendicular to the upward/downward direction and the first direction, and a third direction that is an opposite direction to the second direction, and
wherein the housing includes:
a boss insertion recess opened toward the first direction, and into which the filter boss is inserted.

3. The filter fastening unit assembly of claim 2, wherein the housing includes:
a housing body having the boss insertion recess;
a first extension part extending from the first direction of an insertion area of the housing body, which defines the boss insertion recess, toward a protrusion direction corresponding to the upward/downward direction, which is a direction that faces the filter boss; and
a second extension part extending from the first extension part in an opposite direction to the first direction.

4. The filter fastening unit assembly of claim 3, wherein when a space formed between the second extension part and the insertion area when no external force is applied to the second extension part is defined as a spacing space,
the second extension part is configured to be curved with respect to the first extension part, and at least a portion thereof is disposed in the spacing space when the external force is applied toward the spacing space.

5. The filter fastening unit assembly of claim 4, wherein the spacing space includes:
a first spacing space located in the opposite direction to the first direction of the second extension part and extending upwards and downwards; and
a second spacing space located in an opposite direction to the protrusion direction of the second extension part, and connected to the first spacing space.

6. The filter fastening unit assembly of claim 3, wherein a length of an end in the opposite direction to the first direction of the second extension part, along the upward/downward direction, is larger than a length of an end in the first direction of the second extension part, along the upward/downward direction.

7. The filter fastening unit assembly of claim 1, wherein a lever boss protruding toward the housing is formed at an end of the lever in the opposite direction to the first direction, and
wherein the housing includes:
a housing body: and
a lever boss guide groove formed in the housing body, opened in the first direction and the opposite direction thereto, and into which the lever boss is inserted.

8. The filter fastening unit assembly of claim 7, wherein a rotation point that is a point, at which the lever is connected to the base to be rotatable, is formed in the first direction of the lever boss.

9. The filter fastening unit assembly of claim 7, wherein the lever includes:
a pressing area; and
a connection area extending from the pressing area in a direction crossing a direction, in which the pressing area extends, and connected to the base.

10. The filter fastening unit assembly of claim 7, wherein the filter includes:
a filter body; and
a lever stopping step protruding from the filter body in the first direction, and
wherein the lever includes:
a stopping step insertion opening opened toward an upper side such that the lever stopping step is disposed in an interior thereof when the lever is rotated with respect to the base such that the lever boss is located at an uppermost end of a movement range.

11. The filter fastening unit assembly of claim 7, wherein the base further includes:
a base body; and
a through hole formed in the base body, and passing along a second direction that is one direction that is perpendicular to the first direction, and
wherein the lever includes:
a stop member coupled to the through hole through snap-fitting when the lever is rotated with respect to the base such that the lever boss is located at an uppermost end of a movement range.

12. The filter fastening unit assembly of claim 1, wherein the base includes:
a base body; and
a housing guide hole formed to pass through the base body, and extending along the upward/downward direction, and
wherein the housing includes:
a housing body; and
a housing guide boss protruding from the housing body toward the housing guide hole, and disposed in an interior of the housing guide hole.

13. The filter fastening unit assembly of claim 1, wherein the introduction passage is opened when the filter and the filter coupling part contact each other.

14. The filter fastening unit assembly of claim 13, wherein a communication hole communicated in the upward/downward direction is formed on a lower side of the introduction passage,
wherein the filter coupling part includes:
a valve member having a first area having a diameter that is smaller than a diameter of the communication hole to be disposed in an interior of the communication hole, and a second area located on an upper side of the first area and having a diameter that is larger than a diameter of the communication hole; and
an elastic member configured to elastically support the valve member toward a lower side, and
wherein the filter includes:
a filter body; and
a valve opening boss protruding from the filter body toward an upper side, and configured to press a lower end of the valve member upwards to open the communication hole closed by the second area.

15. The filter fastening unit assembly of claim 14, wherein the filter coupling part includes:
an elastic member disposition space, in which the elastic member is disposed in an interior thereof, and
wherein the introduction passage does not overlap the elastic member disposition space when viewed along an extension direction of the introduction passage.

16. A filter fastening unit assembly comprising:
a base having a base opening;
a housing disposed in the base opening, connected to the base to be movable upwards and downwards, and having a housing opening;
a filter coupling part coupled to an upper side of the base, and including an introduction passage, through which water is introduced, and a discharge passage, through which the water is discharged; and
a lever connected to the base to be rotatable, connected to the housing to be rotatable, and configured to move the housing upwards and downwards when being rotated with respect to the base.
